(19) United States
(12) Patent Application Publication
(10) Pub. No.: US 2009/0034896 A1
(43) Pub. Date: Feb. 5, 2009

(54) BEARING RETAINER

(76) Inventors: Kenneth Lee Fisher, Blue Ash, OH (US); Richard Walker Nicholson, Cincinnati, OH (US); Mark Hopper, West Chester, OH (US); Gary Paul Moscarino, Cincinnati, OH (US); Steven Alan Ross, Cincinnati, OH (US); Michael Slusher, Hamilton, OH (US)

Correspondence Address: GENERAL ELECTRIC COMPANY, GE AVIATION, ONE NEUMANN WAY MD H17, CINCINNATI, OH, 45215, US

(21) Appl. No.: 12/137,042

(22) Filed: Jun. 11, 2008

Related U.S. Application Data
(63) Continuation of application No. 11/833,865, filed on Aug. 3, 2007, now abandoned.

(51) Int. Cl. F16C 33/41; F16C 33/38

(52) U.S. Cl. 384/531; 384/523

(57) ABSTRACT

A bearing retainer having an inner portion, an outer portion spaced apart from said inner portion, and an intermediate portion connecting the inner portion and the outer portion, such that the inner portion and the outer portion are radially spaced apart and define a space therebetween, and a contact surface on at least one of the inner portion and the outer portion for engaging a component of a bearing assembly disposed in the space.

### CROSS-REFERENCE TO RELATED APPLICATION

This application is a continuation-in-part of U.S. patent application Ser. No. 11/833,865, filed Aug. 3, 2007.

### BACKGROUND OF THE INVENTION

The technology described herein relates generally to gas turbine engine components and more specifically to bearing retainers.

Gas turbine engines typically include a compressor, a combustor, and at least one turbine. The compressor may compress air, which may be mixed with fuel and channeled to the combustor. The mixture may then be ignited for generating hot combustion gases, and the combustion gases may be channeled to the turbine. The turbine may extract energy from the combustion gases for powering the compressor, as well as producing useful work to propel an aircraft in flight, such as by driving a fan or propeller, or to power a load, such as an electrical generator.

Rotating turbomachinery, such as that found in gas turbine engines, frequently contains one or more bearing assemblies to support rotating components within stationary housings or between or within other rotating apparatus. Such bearing assemblies typically feature one or more bearing retainers to secure the bearing in place relative to other structures. Bearing retainers may be removable to permit initial assembly and/or repair of elements of the bearing assembly.

Removable bearing retainers often take the form of a nut or collar threadably engaged externally or internally on the end of a shaft or housing. When the shaft or housing is subjected to significant cyclic loads or other radial motion under certain operating conditions, large deflections or distortion of the shaft or housing can occur which diminishes the contact between contacting surfaces of the bearing retainer and the shaft or housing. This diminished contact can lead to the bearing retainer “jumping threads” or otherwise moving axially relative to the shaft or housing and allowing the bearing to move from its installed position due to the loss of positive retention.

Accordingly, there remains a need for a bearing retainer which is removable yet provides for enhanced contact under high deflection or distortion operating conditions.

### BRIEF DESCRIPTION OF THE INVENTION

A bearing retainer having an inner portion, an outer portion spaced apart from said inner portion, and an intermediate portion connecting the inner portion and the outer portion, such that the inner portion and the outer portion are radially spaced apart and define a space therebetween, and a contact surface on at least one of the inner portion and the outer portion for engaging a component of a bearing assembly disposed in the space.

### BRIEF DESCRIPTION OF THE DRAWINGS

FIG. 1 is a cross-sectional schematic view of an exemplary gas turbine engine.

FIG. 2 is a partial cut-away cross-sectional view of an exemplary bearing assembly that may be used with a gas turbine engine, such as the gas turbine engine shown in FIG. 1.

FIG. 3 is an enlarged partial view of the bearing retainer of FIG. 2.

FIG. 4 is a view similar to FIG. 2 of another embodiment of an exemplary bearing assembly.

FIG. 5 is a view similar to FIG. 2 of another embodiment of an exemplary bearing assembly.

FIG. 6 is a cross-sectional view taken along line 6-6 of FIG. 2.

FIG. 7 is a cross-sectional view similar to FIG. 6 taken along line 7-7 of FIG. 2.

FIG. 8 is a partial perspective view of the exemplary bearing retainer of FIG. 2.

### DETAILED DESCRIPTION OF THE INVENTION

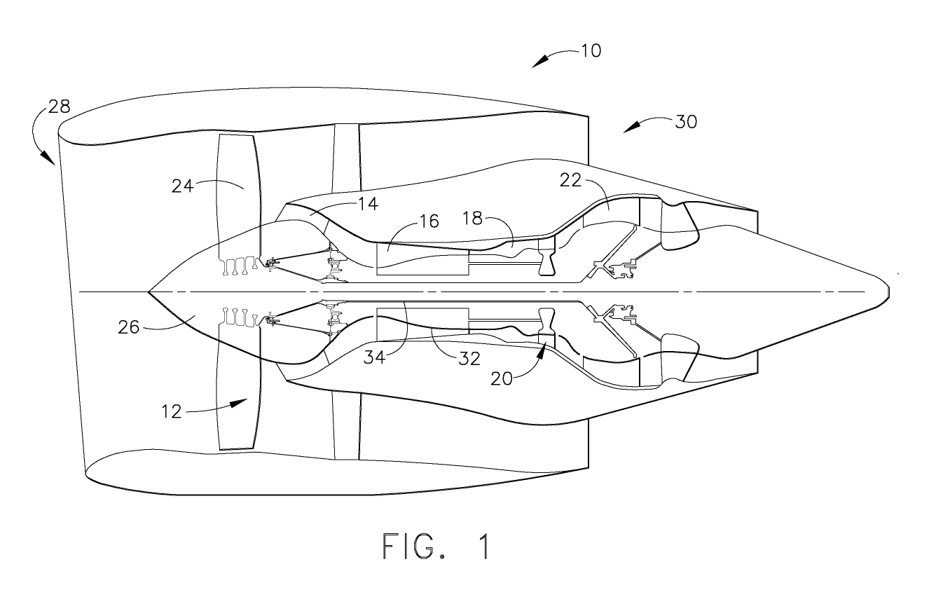

FIG. 1 is a schematic illustration of an exemplary gas turbine engine 10 including a fan assembly 12, a booster 14, a high pressure compressor 16, and a combustor 18. The engine 10 also includes a high pressure turbine 20, and a low pressure turbine 22. The fan assembly 12 includes an array of fan blades 24 extending radially outward from a rotor disk 26. The engine 10 has an intake side 28 and an exhaust side 30. The engine 10 may be any gas turbine engine. For example, the engine 10 may be, but is not limited to being, a GE90 gas turbine engine available from General Electric Company, Cincinnati, Ohio. The fan assembly 12, booster 14, and turbine 22 may be coupled by a first rotor shaft 32, and the compressor 16 and turbine 20 may be coupled by a second rotor shaft 34.

In operation, air flows through the fan assembly 12 and compressed air is supplied to the high pressure compressor 16 through the booster 14. The highly compressed air is delivered to the combustor 18, where it is mixed with a fuel and ignited to generate combustion gases. The combustion gases are channeled from the combustor 18 to drive the turbines 20 and 22. The turbine 22 drives the fan assembly 12 and booster 14 by way of shaft 32. The turbine 20 drives the compressor 16 by way of shaft 34.

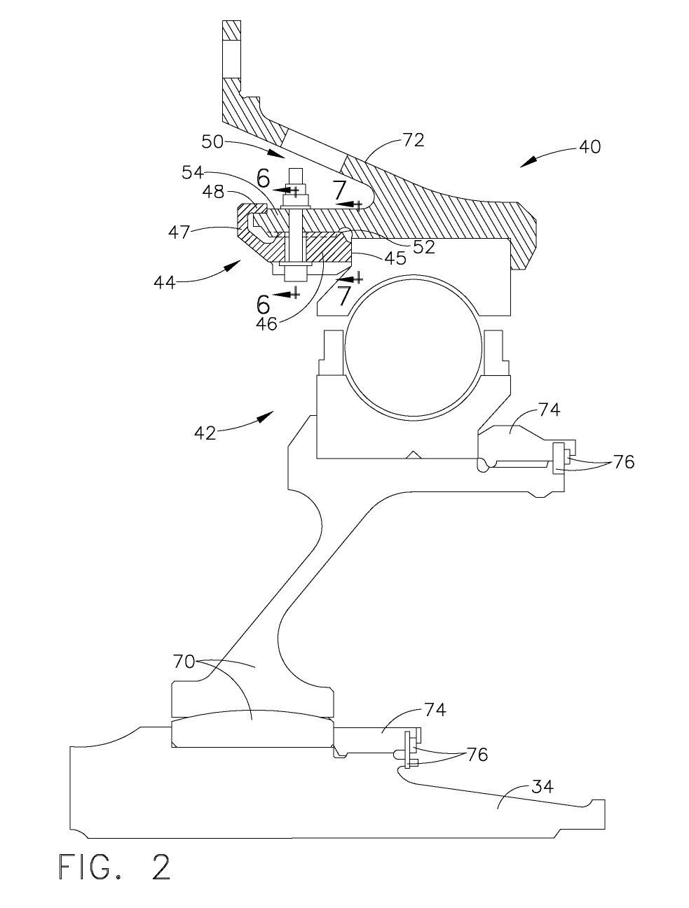

As shown in FIG. 2, the engine 10 includes a bearing assembly 40. Bearing assembly 40 includes a bearing 42, a bearing retainer 44, and a positive retention element 50. Bearing retainer 44 includes an inner portion 46, an outer portion 48, and an intermediate portion 47 which connects the inner portion 46 and outer portion 48. In the embodiment shown, the bearing retainer 44 is formed as an annular spanner nut with the inner and outer portions being laterally (in this instance radially) spaced apart and with a threaded contact surface 52 formed on the inner portion 46.

Bearing assembly 40 also includes a shaft extension 70 and a bearing housing 72, as well as retainers 74 which may be formed as spanner nuts and secondary retention devices 76. Contact surface 52 engages a component of the bearing assembly 40, such as bearing housing 72, to secure the bearing retainer 44 and thereby secure the bearing 42 within the housing 72. Contact surface is configured so that such engagement is releasable, such that the contact surface and the bearing retainer are removably secured to the component, in this case the housing 72. Removable securement allows for assembly of the components as well as disassembly for repair or replacement of components.

As shown in FIG. 2, the inner and outer portions are radially spaced apart via the intermediate portion and define a space therebetween to capture between them (i.e., in the space they define therebetween) the element they are secured to so they follow such element through the range of motion, even during distortion, without disengaging from contact with the element. Depending upon the relative dimensions of the inner, outer, and intermediate portions, and their respective shapes, the bearing retainer 44 may have a c-shaped, j-shaped, “scorpion-shaped” (i.e., resembling a scorpion in profile with the tail extending rearward, upwardly, and then forward over the rear portion of the body), or other desired cross-section.

The outer portion of the bearing retainer may be formed as a complete annular structure, such as depicted in the accompanying drawing figures. Alternatively, the outer portion may be formed as one or more annular segments.

The retainer maintains the thread engagement of the inner portion 46 and the threaded contact surface 52 because when the bearing housing, for example, tries to ovalize and pull away radially from the retainer, the outer portion 48 of the retainer is there to engage the housing and thus pull the retainer along with it, thereby keeping the threads engaged. The smaller the gap and the more overlap between the tail of the outer portion 48 and the housing the more certain it is the parts will follow each other during deformation.

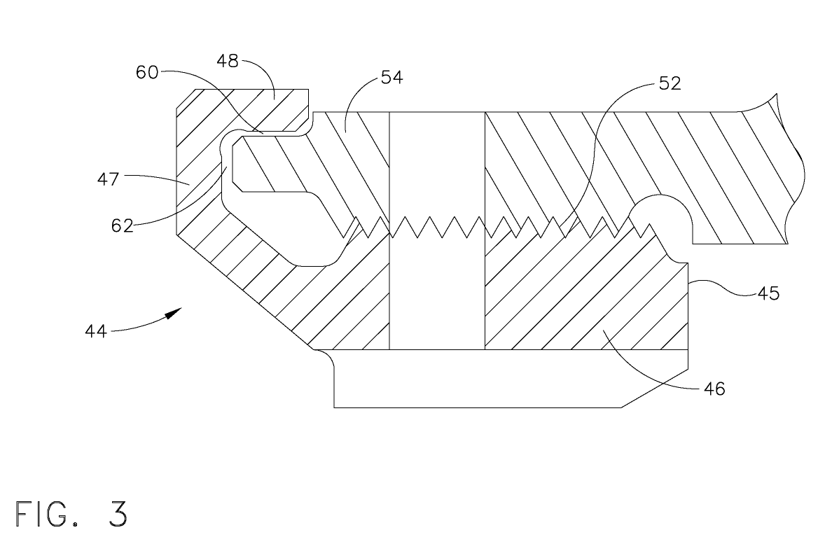

FIG. 3 is an enlarged partial view of the bearing retainer of FIG. 2, which shows in greater detail the spatial relationship of the retainer to the housing. The amount of thread disengagement before the retainer fully moves with the bearing is controlled by the radial gap 60 between the outer portion 48 of the retainer 44 and the housing extension 54 and the stiffness of the retainer 44. The smaller the gap and the more overlap between the tail of the outer portion 48 and the housing extension 54 the more certain it is the parts will follow each other during deformation. Therefore, the gap 60 is minimized but designed so as not to close during all anticipated normal assembly and operating conditions.

An axial gap 62 is also defined between the intermediate portion 47 and the housing extension 54. Like the radial gap 60, axial gap 62 is minimized but designed so that the intermediate portion 47 and housing extension 54 will not make contact before the bearing contacting surface 45 makes contact with the bearing 42. This relationship ensures that positive axial retention of the bearing 42 is provided by the retainer 44. The bearing retainer 44 is therefore sized and adapted to contact and secure the mating element, such as bearing 42, with the contact face 45 before the connecting portion 47 contacts the housing extension 54.

Bearing retainer 44 may be formed using any suitable manufacturing method. For example, bearing retainer 44 may be unitarily formed from a single piece of material, as shown in FIG. 2, or may be formed from two or more, i.e., multiple, individual elements which are joined together via any method suitable for the material or materials to be joined. By way of example, bearing retainer 44 may be unitarily formed from a single forging and machined as necessary to impart the desired geometry and surface finish. As another example, bearing retainer 44 may be formed of two or more separate pieces of material which are bonded to one another, such as brazing, soldering, or welding metallic elements together.

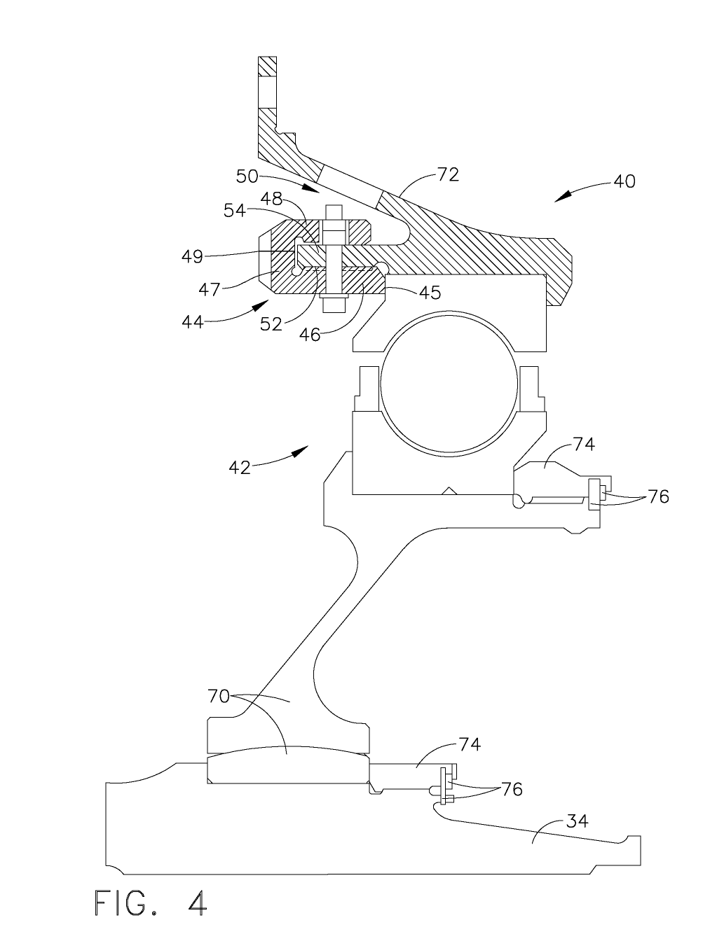

FIG. 4 illustrates an alternative construction of the bearing retainer 44. As shown in FIG. 4, the bearing retainer 44 is formed as a two-piece construction with the inner portion 46 and outer portion 48 each including a segment of the intermediate portion 47, each of the mating surfaces of the intermediate portion 47 being welded together via a welded seam 49 to form an integral bearing retainer assembly.

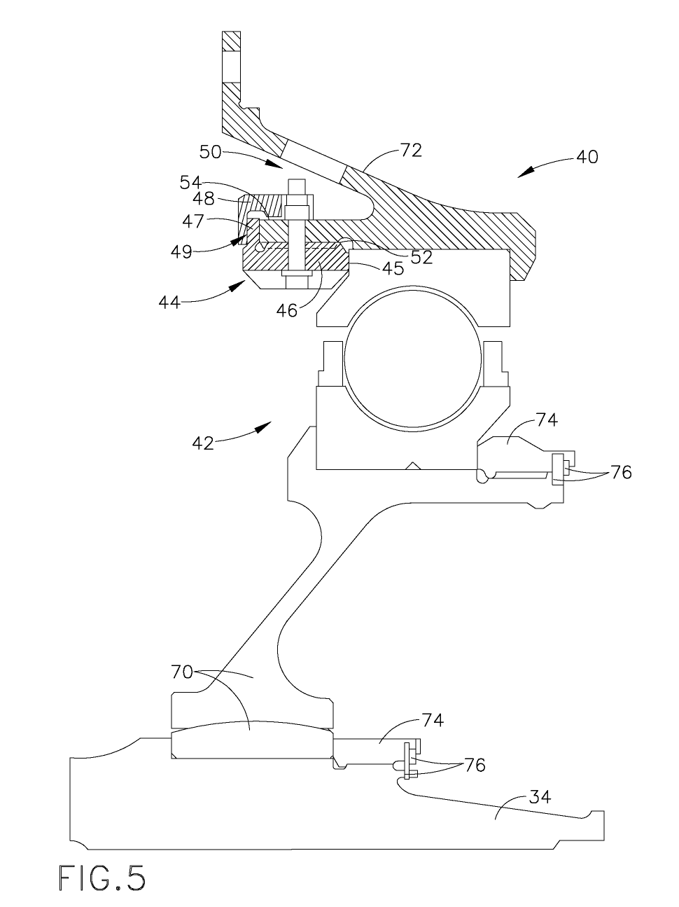

FIG. 5 illustrates another alternative construction of the bearing retainer 44. As shown in FIG. 5, the bearing retainer 44 is formed as a two-piece construction with the inner portion 46 and outer portion 48 each including a segment of the intermediate portion 47, each of the mating surfaces of the intermediate portion 47 being brazed together via a brazed seam 49 to form an integral bearing retainer assembly.

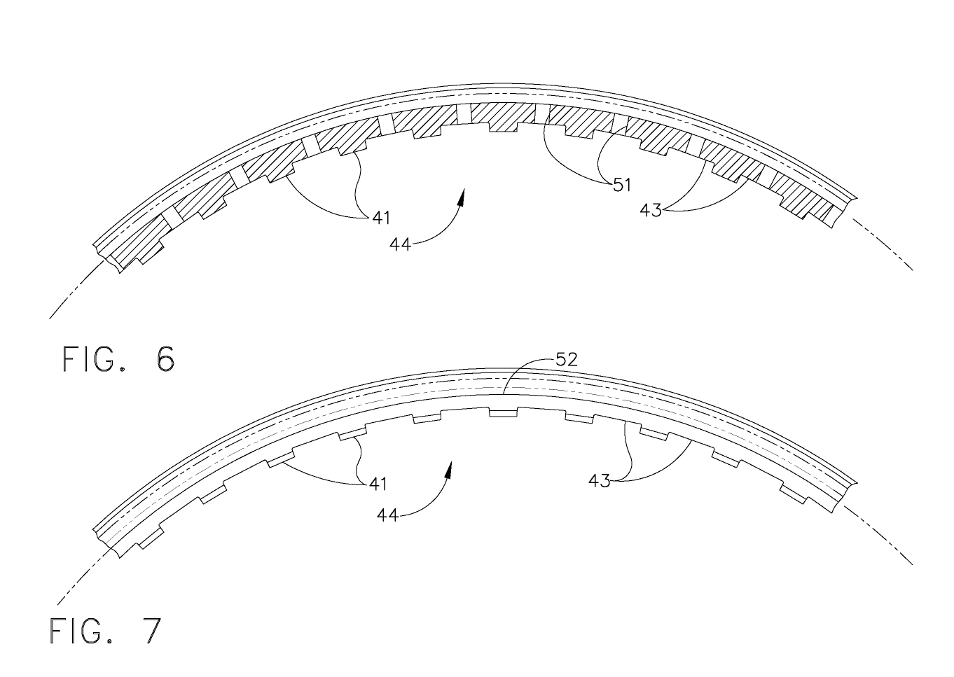

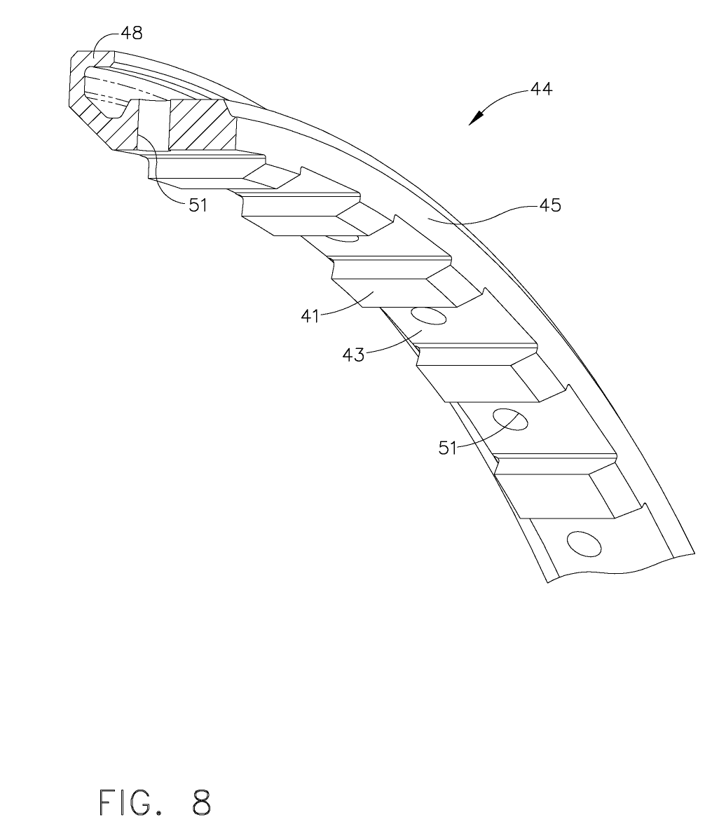

In FIGS. 2, 4, and 5, a positive retention feature 50 is included to prevent the bearing retainer 44 from rotating during vibrations and other forces encountered during gas turbine engine operation. This in turn prevents the bearing retainer from loosening due to rotating and following the threads on the contacting surface away from the fully-seated position. Any type of positive retention feature may be utilized, such as a bolt, screw, cotter pin, key and keyway, lockwire, or polymeric anti-rotation compound such as may be commercially available. In the exemplary embodiment shown, positive retention feature 50 takes the form of a bolt with a complementary nut. Apertures may be provided in the bearing retainer 44 as needed for installation of the positive retention feature, such as the apertures 51 shown in FIGS. 6 and 8. Depending upon the type of positive retention feature required for the particular installation, the positive retention feature may comprise a single device or a plurality of devices, and accordingly may require a single aperture, slot, or other anchoring mechanism or a plurality of such anchoring mechanisms to be provided in the bearing retainer 44.

FIGS. 6 and 7 are cross-sectional views taken along lines 6-6 and 7-7, respectively, of FIG. 2. FIGS. 6 and 7 highlight details of the construction of the bearing retainer 44. The bearing retainer 44 in the exemplary embodiment shown includes a plurality of radially inwardly facing alternating teeth 41 and slots 43 which may be used as a tooling engagement feature to thread the bearing retainer 44 onto the bearing housing extension 54 and tighten it securely using a spanner wrench or other appropriate assembly tooling. However, depending upon the assembly and installation method to be utilized, any type of tooling engagement feature may be provided in either single or multiple form.

The bearing retainers described herein may be made of any material known in the art. Typical materials may be AMS 5643 stainless steel or any other steel alloy such as AMS 6414, nickel steels such as INCO 718, or titanium alloys. The choice of the material depends upon thermal, load, assembly, and operating environment and mating material, but is not limited to any particular material or class of materials.

Bearing retainers of the type described herein may be useful in other installations besides gas turbine engines. For example, such retainers may be utilized in the automotive field or any other field where it is desired to retain a bearing in position during operation. The technology described herein may be applicable to any rotating machinery application where high load events may be of concern. Although initially envisioned and developed for rotating machinery, there may be potential for use on static machinery as well.

While this application has described various specific exemplary embodiments, those skilled in the art will recognize that those exemplary embodiments can be practiced with modification within the spirit and scope of the claims.

What is claimed is:

1. A bearing retainer comprising:
an inner portion;
an outer portion spaced apart from said inner portion;
an intermediate portion connecting said inner portion and said outer portion, such that said inner portion and said outer portion are radially spaced apart and define a space therebetween; and
a contact surface on at least one of said inner portion and said outer portion for engaging a component of a bearing assembly disposed in said space.

2. The bearing retainer of claim 1 wherein a controlled radial gap is defined between one of said inner portion and said outer portion and said component.

3. The bearing retainer of claim 1 wherein said contact surface comprises a threaded surface.

4. The bearing retainer of claim 3 wherein said bearing retainer is formed as an annular nut and said contact surface is formed on said inner portion.

5. The bearing retainer of claim 1 wherein said bearing retainer has a generally c-shaped cross-section.

6. The bearing retainer of claim 1 wherein said bearing retainer is unitarily formed.

7. The bearing retainer of claim 1 wherein said bearing retainer is formed from two or more individual elements.

8. The bearing retainer of claim 1 wherein said bearing retainer has a scorpion-shaped cross section.

9. The bearing retainer of claim 1 wherein said contact surface is removably secured to said component.

10. The bearing retainer of claim 1 wherein said bearing retainer includes at least one positive retention element.

11. The bearing retainer of claim 1 wherein said bearing retainer includes at least one tooling engagement feature.

12. The bearing retainer of claim 1 wherein said bearing retainer includes a plurality of tooling engagement features in the form of alternating teeth and slots.

13. The bearing retainer of claim 1 wherein said component comprises a bearing housing.

14. The bearing retainer of claim 1 wherein said bearing retainer is annular in shape and said inner portion and said outer portion are radially spaced apart.

15. A bearing retainer comprising:
an inner portion;
an outer portion spaced apart from said inner portion;
an intermediate portion connecting said inner portion and said outer portion, such that said inner portion and said outer portion are radially spaced apart and define a space therebetween;
a threaded contact surface on said inner portion for engaging a component of a bearing assembly disposed in said space; and
a controlled radial gap between said outer portion and said component.

16. A bearing assembly comprising a housing, a bearing, and a bearing retainer for removably securing said bearing in said housing, said bearing retainer comprising:
an inner portion;
an outer portion spaced apart from said inner portion;
an intermediate portion connecting said inner portion and said outer portion, such that said inner portion and said outer portion are radially spaced apart and define a space therebetween;
a threaded contact surface on said inner portion for engaging a component of a bearing assembly disposed in said space; and
a controlled radial gap between said outer portion and said component.
